(19) United States
(12) Patent Application Publication
(10) Pub. No.: US 2007/0176430 A1
(43) Pub. Date: Aug. 2, 2007

(54) Fluid Powered Oscillator

(76) Inventor: Mark D. Hammig, Dexter, MI (US)

Correspondence Address: Mark Hammig, 875 N. Lima Center Road, Dexter, MI, 48130, US

(21) Appl. No.: 11/307,337

(22) Filed: Feb. 1, 2006

(51) Int. Cl. H02P 9/04; F03B 13/00

(52) U.S. Cl. 290/54

(57) ABSTRACT

A method and device for converting fluidic kinetic energy into oscillatory mechanical motion is disclosed. A mechanical structure of finite stiffness is coupled to a fluid-dynamical control surface the thrust from which is oscillated in direction. The coupling thereby induces oscillations in the structure, the magnitude of which can be controlled by the degree of mechanical resonance between the oscillation rate of the fluidic thrusting and the structure's resonance frequency. The resulting mechanical energy can be converted into electrical energy using either piezo-electric or electromagnetic means.

### FIELD OF THE INVENTION

In general, this invention relates to methods and devices that transform fluidic kinetic energy into mechanical motion. More specifically, it relates to those methods and devices that extract either useful work or information from a fluid flow by its coupling to a mechanical system.

### BACKGROUND OF THE INVENTION

Since antiquity, fluidic forces have been exploited to perform useful work, in such applications as sailing ships and waterwheels. More recently, wind turbines and hydroelectric plants have been used to transform air and water currents, respectively, into electrical power. Typically, that transformation is mechanically elicited by converting the flow into a rotational motion, from which electricity can be generated using well-established technologies.

Mechanical systems have also been used to characterize the nature of the flow; for example, anemometers are commonly used to determine wind speeds and wind vanes allow one to assess the local flow direction. By understanding the details of the interaction between a mechanical device and the fluid under study, useful information can thus be gleaned. As in the case of energy conversion systems, information-gathering devices typically convert the fluid energy into rotational motion.

Rotational mechanical systems suffer on both practical and theoretical grounds. From a practical standpoint, the generators and transmissions common in such systems suffer from relatively poor reliability, and therefore possess high maintenance costs. Furthermore, for the specific case of a wind turbine mounted horizontally on a tower—the most common configuration—the rotors and the electrical conversion hardware must be installed at elevation, requiring a strong support structure, maintenance duties at hazardous heights, and heavy machinery to accomplish the installation. Vertically mounted turbines can alleviate some of these concerns, but suffer from poorer aerodynamic performance. One further disadvantage of a rotational energy-conversion system is that, in principle, the area of its rotor limits its output power.

Many prior art systems have attempted to address the inherent disadvantages of rotational methods. For example, the mechanical complexity inherent to wind turbines can be avoided by using a charged aerosol electric power generator, as described, for instance, in U.S. Pat. No. 4,433,248. Among their other problems, charged aerosol generators fail to alleviate the main theoretical disadvantage of rotor designs; that is, the output power still depends on the area subtended by the device.

Linear motion wind driven power plants have also been explored, in which one or more carriages having airfoils attached are moved about a closed-loop track by the wind. Examples include: U.S. Pat. No. 5,992,341, U.S. Pat. No. 665,810; and U.S. Pat. No. 4,114,046. Such systems fail to substantially decrease the machine complexity, and further, they require a much greater physical footprint for installation, a nontrivial environmental concern given the low energy density inherent to wind flows.

The present invention alleviates the disadvantages of rotational systems by using a control surface to drive a mechanical element into resonant vibration. The ability of a fluid flow to drive a mechanical system into resonance is well known. In fact, wind machines are designed so that the forces acting on the structure do not drive the tower or the blades into destructive resonant vibration. Prior art systems have been developed to damp such oscillations, as described, for example, in U.S. Pat. No. 6,626,642 and U.S. Pat. No. 2,292,072. The present invention encourages resonant vibration so that the amplified mechanical motion can be transformed into an electric current.

Some prior art systems have converted fluid motion into oscillating mechanical elements. For example, U.S. Pat. No. 5,324,169 describes a lateral support arm that is driven into oscillation by a fluid flow. In that system, the oscillation is used to rotate a vertical drive shaft and doesn't take advantage of the mechanical resonance of a deflecting element, as done in the present invention.

### OBJECTS AND ADVANTAGES

In view of the shortcomings of the prior art, it is a primary object of the present invention to provide a method and device for converting fluidic kinetic energy into oscillatory mechanical motion, thereby creating an alternative modality for extracting useful work from fluid flows. The object of the present invention is thus to first, provide a method that converts fluid flows into linear motion; and second, to provide a method by which that motion is converted into electrical energy with high reliability. A further object of the invention is to take advantage of the amplifying properties of mechanical resonance so that relatively weak fluid flows can be transformed into mechanical motions from which useful work can be extracted. Furthermore, the object of the present invention is to allow the conversion of mechanical energy into electrical energy using devices that are, mechanically, relatively simple.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, the energy transformation method and device described herein includes the following: (a) a mechanical structure of finite stiffness, (b) an airfoil or other fluid-dynamical structure that interacts with the incident fluid flow to produce a force, (c) a means by which that force can be coupled to pliable structure and therefore induce its motion, and (d) a method of oscillating the direction of that fraction of the fluidic forcing that is applied to the pliable body so that the entire mechanical structure oscillates. For example, if the orientation of an airfoil is controlled so that the lateral thrust acting upon it is oscillated, then that airfoil can be placed atop a pole or tower and thereby induce its oscillation. The resulting linear oscillatory mechanical motion can be converted to electrical energy using various techniques, including piezo-electric and electromagnetic methods, embodiments of which are described in this specification.

### BRIEF DESCRIPTION OF THE DRAWINGS

The description is accompanied by drawings that are given by way of illustration only, and thus are not limitative of the present invention, and in which embodiments of the present invention are described. In the drawings:

FIG. 1 is a diagram illustrating the principle components of the invention;

FIG. 2 is a diagram of a method by which the oscillation of a mechanical structure may be induced by a fluid flow, in which one oscillates the direction of the fluidic forcing by varying the orientation of the control surface;

FIG. 3 is a diagram illustrating the motion of the preferred embodiment of the invention when viewed looking into the direction of the fluid flow;

FIG. 4 is a diagram of an alternative embodiment of the invention, in which active means consisting of a sensor, a controller, and an actuator are employed to oscillate the direction of the fluidic forcing;

FIG. 5 is diagram of the preferred embodiment of the invention, in which a piezo-electric layer—sandwiched between two, electrode layers—is used to convert the mechanical oscillation into electrical energy;

FIG. 6 is a diagram of an alternative embodiment of the invention, in which a capacitive structure, mounted parallel to the oscillation direction of the main structure, is used to convert the mechanical oscillation into electrical energy;

FIG. 7 is a diagram of an alternative embodiment of the invention, in which a capacitive structure, mounted perpendicular to the oscillation direction of the main structure, is used to convert the mechanical oscillation into electrical energy.

### DETAILED DESCRIPTION OF THE INVENTION

Reference will now be made in detail to the present preferred embodiments of the invention, examples of which are illustrated in the accompanying drawings. Similar or identical structures in the figures are represented by identical callouts.

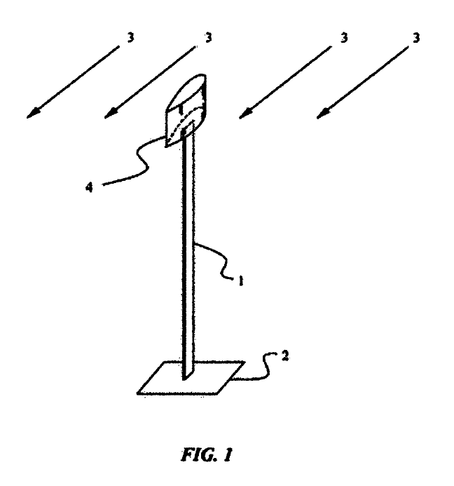

The present invention will best be understood by reference to FIG. 1, in which the principle components of the invention are illustrated. The mechanical structure of finite stiffness 1 may take many forms; in typical practice, it may take the cantilever shape like that shown in the figure, or it may assume the form of a bridge, or a membrane-element, and will also be referred to as a “lever”. Its most critical feature is that it is capable of deflection in response to environmental influences.

If structure 1, rigidly mounted to base 2, is placed in air-stream 3, then the structure will deflect in response to the fluid flow in a direction and with a magnitude dependent on the fluid-dynamical forces acting on the body. If the fluidic forces acting on the structure do not change in magnitude and/or direction upon deflecting the lever, then the structure will deflect to a new equilibrium position, with a response governed by its mass, its stiffness, and its damping ratio, as is well known.

The structure 1 may stand alone, optimized for its mechanical characteristics, or it may include one or more airfoil elements 4, designed to optimally interact with the fluidic environment. If the orientation of airfoil 4 is fixed in position relative to the bearing of structure 1, then the initiation of a constant fluid flow will result in the deflection of structure 1 to a new equilibrium position following its exponential decay. However, if the fluid forces are made to vary with the position of the deflecting structure 1, then the lever can be made to oscillate.

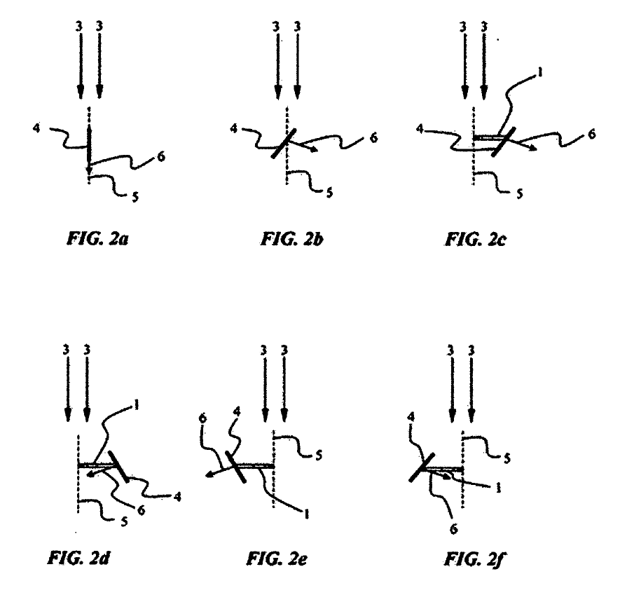

For instance, FIG. 2 shows a sequence of airfoil positions that will result in the oscillation of structure 1, all shown looking down on the fluid powered resonator. In FIG. 2a, airfoil (or blade) 4 is oriented relative to wind direction 3, such that resulting fluidic force 6 is oriented parallel to the main axis 5 of the mechanical structure. As a result, the effect of the wind is to simply deflect structure 1 in the direction of fluid flow, and no lateral movement results. However, if blade 4 is turned as shown in FIG. 2b, such that resultant force 6 has a lateral component, then the structure will begin to deflect perpendicular to the wind direction resulting in its movement to the position shown in FIG. 2c.

If the orientation of blade 4 is fixed to that shown in FIG. 2c then the structure will remain deflected in the position shown; however, if the blade is rotated to the orientation shown in FIG. 2d, then resultant force 6 will begin to move mechanical structure 1 to the left until the oscillator reaches its new equilibrium position shown in FIG. 2e. If the orientation of blade 4 is again reversed, as shown in FIG. 2f, then mechanical structure 1 will move to the right.

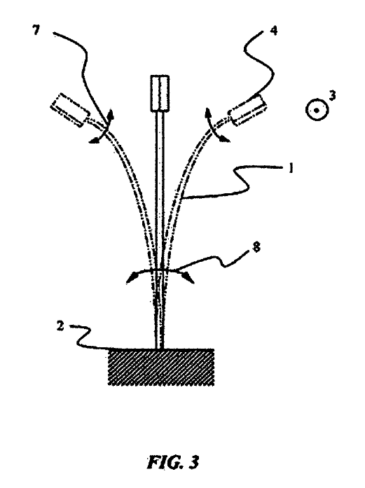

The compliant structure 1 can therefore be made to oscillate between the positions shown in FIGS. 2c and 2f by appropriately altering the orientation of the airfoil. The process outlined in FIG. 2 shows the embodiment that best illustrates the principles of the invention. For the sake of clarity, FIG. 3 shows the movement of the fluid powered oscillator as viewed from behind the structure. The arrow coming out of the page indicates fluid flow direction 3, consistent with that shown in FIGS. 1 and 2. As suggested in the figure, airfoil oscillation 7 induces structural oscillation 8 in the main body 1, which is fixed to mount 2.

Any method that produces an oscillation in the fluidic forcing acting on structure 1 will induce the desired oscillation in the main body. The airfoil can take many forms and can, in fact, be disregarded if structure 1 is fabricated to alter its properties upon deflecting in the air stream. Furthermore, one can alter the orientation of the blade using either active or passive techniques. Finally, the mechanical energy induced in the structure can be converted to electrical energy by a variety of methods. In order to clarify the breadth of these choices, we will first describe the preferred embodiment and then elucidate the alternative embodiments of the invention.

In the preferred mechanical embodiment of the invention, we separate the device's mechanical response from its fluid-dynamical response by building a compound oscillator, as shown in FIG. 1. The long structural element 1 is optimally designed to possess a small stiffness, a high resonance frequency, and a small damping ratio. The mechanical energy that can be induced in the body is limited by the magnitude of the structure's deflection and its resonance frequency. Higher frequencies and larger deflections result in more mechanical power, as is well known. Furthermore, the damping ratio determines the strength of the resonance, since for small damping ratios small fluidic forces can induce large mechanical deflections. Conversely, if mechanical structure 1 is highly damped, then a given force regime will produce smaller deflections.

As shown in the preferred embodiment in FIG. 1, airfoil 4 is placed at the apex of structure 1 in order to take advantage of the higher wind velocities that generally accompany higher elevations; however, in other embodiments, the airfoils can be placed at other locations along the body. Furthermore, in an alternative mechanical embodiment, the body itself can be designed to produce the desired oscillatory behavior when encountering a steady fluid flow. If mechanical structure 1 is fabricated so that upon deflection, its leading edge is much stiffer than its trailing edge, then the structure's cross-section can be made to mimic the blade profile shown in FIG. 2, and oscillation will result.

The variety of methods by which the airfoil can be actuated will now be discussed. The actuation methods can generally be described as either: a) active, b) passive, or c) self-actuating. In the preferred embodiment, the airfoil orientation is controlled passively, in the sense that the action of the actuator is not coupled to the behavior of the mechanical structure. Recall that one of the features of the invention is that the deflecting structure is driven purposefully into resonance in order to maximize the size of its response. If one oscillates the angle-of-attack of the airfoil at the same frequency as the structure's mechanical resonance, then a steady air flow will induce structural oscillations, the magnitude of which are determined by the structure's mechanical properties as well as the magnitude of the fluidic forcing. Note that the blade actuating method itself can be any of the many techniques that are well established in the prior art; for example, one can employ a stepper motor and tie-arms (not shown) in order to vary the blade position.

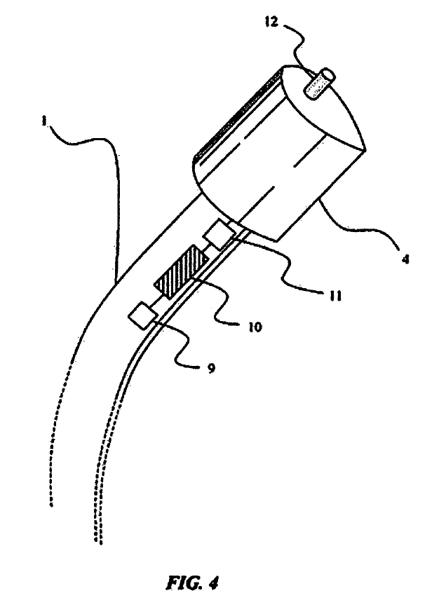

In an alternative embodiment, one can use active techniques to control the fluidic forcing and produce the motion shown in FIG. 2. As outlined in FIG. 4, if motion sensor 9, which may be an accelerometer for example, is attached to mechanical structure 1, then its signal can be used to monitor the behavior of the body. That signal can be conditioned through controller 10 to provide an actuating signal to actuator 11, which may then be used to oscillate airfoil 4 about the shaft 12. As mentioned above, controller schemes, motion-sensing methods, and actuating techniques are all well established in the prior art.

A further alternative embodiment employs self-actuating techniques, in which the variation in the airfoil position is due solely to the mechanical and fluid-dynamical forces acting upon it. We already mentioned a mechanical structure whose cross-sectional area flexes in a non-uniform fashion to produce the blade profile shown in FIG. 2. Alternatively, the previously mentioned invention described in U.S. Pat. No. 5,324,169 can be used as the airfoil element 4 sitting atop the structure and thereby producing the desired FIG. 2 behavior. If combined with the present invention, then the oscillating lateral thrust generator described in U.S. Pat. No. 5,324,169 would be designed so that its oscillation frequency equaled the resonance frequency of structure 1. Self-oscillatory methods benefit from the fact that electrical power is not needed to control the orientation of the airfoil and are therefore an important embodiment of the invention.

The fluid powered resonator can be applied to extract either information or energy from fluid flows. There are many methods by which mechanical oscillation can be utilized; however most involve the conversion of the mechanical energy into electrical energy. We will describe the present preferred embodiment as well as alternative embodiments for accomplishing that conversion, while noting that conversions into optical, gravitational, and other forms of energy are equally within the scope of the present invention.

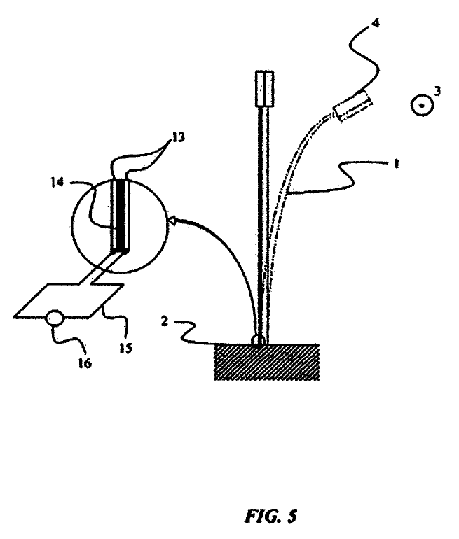

The preferred method of converting the mechanical motion into electrical energy is illustrated in FIG. 5. As shown there, if piezo-electric layer 14 is deposited on the surface of structure 1, then any flexure in that structure will induce a voltage in the piezo-electric material. That voltage can be read out by measuring the voltage difference between two electrodes 13 which bound the piezo-electric material. The electrical energy can therefore be utilized by detecting its magnitude with voltmeter 16, as formed in circuit 15. When one is using piezo-electric techniques therefore, the electrical power response typically mirrors the mechanical response of structure 1.

The piezo-electric material may be deposited using techniques known in the prior art. For example, lead-zirconate-titanate (PZT) has been employed using chemical solution deposition techniques, as shown for example, by M. Hu et al. in “Fabrication of PZT Micro Devices Using a High Yield Sol-Gel Process”, Micro- and Nanotechnology: Materials, Processes, Packaging, and Systems II, Proceedings of SPIE, v. 5650, (SPIE, Bellingham, Wash., 2005). Many additional techniques are also employed for macroscopic size-scales, and are briefly outlined by G. Malyavanatham et al. in “Thick films fabricated by laser ablation of PZT microparticles”, J. of Materials Processing and Technology, v. 168 (2005). Piezo-electric techniques have the advantage of not requiring those additional components that are required when one is using electrostatic or electromagnetic techniques—methods that will be described below in more detail. Furthermore, as the strength of the fluid flow varies and the deflection magnitude therefore increases, the electrical power returned by the oscillator readily scales without complication, whereas eletrostatic and electromagnetic techniques may require the adjustment of the small gaps that are typically employed between the various components.

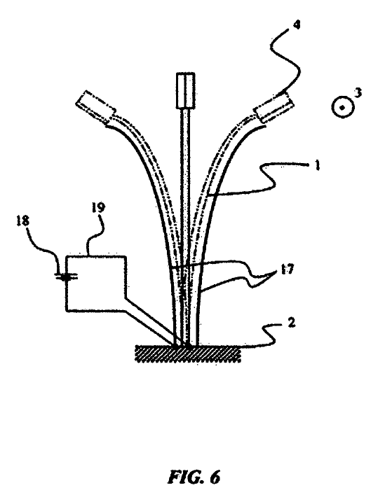

An additional mechanical energy conversion embodiment is shown in FIG. 6, in which electrostatic and electromagnetic techniques are employed. The components used to enable those techniques can be arranged either parallel or perpendicular to the main axis of the mechanical structure. FIG. 6 shows the arrangement in which the components are arranged parallel to the main axis of structure 1. That is, if one builds rigid versions of the deflected form of structure 1, denoted by 17 in the figure, and places them parallel to the oscillating body, then capacitive and inductive structures can be formed. If voltage source 18 produces a differential voltage between structure 1 and electrode 17, then motion in the structure will result in variations in the capacitive current developed in circuit 19, a current that can then be used to produce electrical power. One can forgo the need for a voltage supply by using ferromagnetic materials in either structure 1 or electrode 17, and thereby produce an inductive current in circuit 19. There are, of course, many variations on electrode placement, material selection, and circuit design that serve as additional embodiments to the invention.

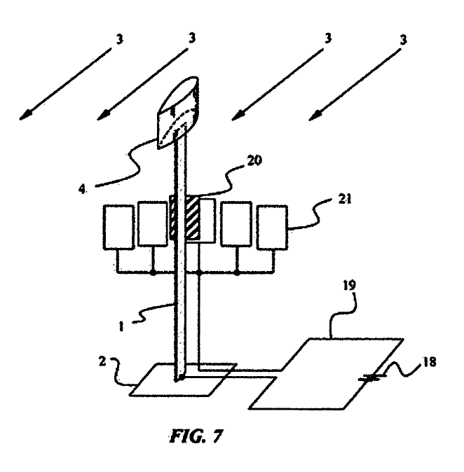

For example, FIG. 7 shows a configuration in which the electrodes are arranged perpendicular to the main axis of the deflecting structure. Specifically, if conductive plate 20 is mounted to structure 1 and further, if a rigid array of plates 21 are placed parallel to moving plate 20, then the deflections 7 will cause variations in the geometry between moving plate 20 and fixed plate array 21. If voltage source 18 then produces a voltage difference between plate 20 and plate array 21, then the resulting capacitive current in circuit 19 can be used to extract the energy information. As in the case of the parallel placement in FIG. 6, current loops and/or magnetic materials can be used in place of the voltage source to generate inductive currents in the readout circuit 19, as an alternative method of extracting the mechanical energy.

The embodiments were chosen and described in order to best explain the principles of the invention and its practical application to thereby enable others skilled in the art to best utilize the invention in various embodiments and with various modifications as are suited to the particular use contemplated. The scope of the invention should be determined by the claims appended hereto and their legal equivalents, rather than by the examples given.

What is claimed is:

1. A method for transforming fluidic kinetic energy into electrical energy, which
comprises in combination:
(a) a mechanical structure of finite stiffness,
(b) means for applying a force upon said structure,
(c) means for coupling the fluidic kinetic energy with said forcing means,
(d) means for oscillating the direction of said forcing means, and
(e) means for converting said motion into electrical energy,
whereby said electrical energy is generated.

2. The energy transformation method of claim 1 wherein said means for converting the oscillatory motion into electrical energy comprises:
(a) means for creating an electromagnetic field about said structure, and
(b) means for detecting variation in said electromagnetic field.

3. The means for converting oscillatory motion into electrical energy of claim 2 wherein said means for creating an electromagnetic field is a capacitive structure.

4. The means for converting oscillatory motion into electrical energy of claim 2 wherein said means for creating an electromagnetic field is an inductive structure.

5. The energy transformation method of claim 1 wherein said mechanical structure has a resonance frequency substantially equal to the frequency of the alternating current variations in the electrical grid.

6. The energy transformation method of claim 1 wherein said means for coupling the fluidic kinetic energy with said forcing means is an airfoil.

7. The energy transformation method of claim 1 wherein said means for oscillating the direction of said forcing means is an aerodynamic structure that applies an oscillating lateral thrust in response to steady fluid flows.

8. The energy transformation method of claim 1 wherein said means for oscillating the direction of said forcing means oscillates at the resonance frequency of the mechanical structure.

9. The energy transformation method of claim 1 wherein said means for oscillating the direction of said forcing means comprises: (a) means for sensing the mechanical motion of said structure; and (b) means for coupling said sensing means with said forcing means.

10. The energy transformation method of claim 1 wherein said means for converting the oscillatory motion into electrical energy is a piezoelectric structure.

11. A method for transforming fluidic kinetic energy into oscillatory mechanical motion, which comprises in combination:
(a) a mechanical structure of finite stiffness,
(b) means for applying a force upon said structure,
(c) means for coupling the fluidic kinetic energy with said forcing means, and
(d) means for oscillating the direction of said forcing means,
whereby said fluidic kinetic energy is transduced into the oscillatory motion of said structure.

12. The energy transformation method of claim 11 wherein said means for coupling the fluidic kinetic energy with said forcing means is an airfoil.

13. The energy transformation method of claim 11 wherein said means for varying the direction of said forcing means is an aerodynamic structure that applies an oscillating lateral thrust in response to steady fluid flows.

14. The energy transformation method of claim 11 wherein said means for varying the direction of said forcing means oscillates at the resonance frequency of the mechanical structure.

15. The energy transformation method of claim 11 wherein said means for varying the direction of said forcing means comprises: (a) means for sensing the mechanical motion of said structure, and (b) means for coupling said sensing means with said forcing means.

16. A device for transforming fluidic kinetic energy into electrical energy, which comprises in combination:
(a) a mechanical structure of finite stiffness,
(b) a piezo-electric layer deposited on said structure,
(c) means for measuring the voltage developed across said piezo-electric layer,
(d) means for creating a force from said fluidic kinetic energy,
(e) mechanical means for coupling said force-creation means with said structure, and
(f) means for oscillating the direction of the force that results from said force-creation means,
whereby said fluidic kinetic energy is transformed into electrical energy.

17. The transformation device of claim 16 wherein said means for creating a force from said fluidic kinetic energy is an airfoil.

18. The transformation device of claim 16 wherein said means for oscillating the direction of said force is an aerodynamic structure that applies an oscillating lateral thrust in response to steady fluid flows.

19. The transformation device of claim 16 wherein said means for oscillating the direction of said forcing means varies at the resonance frequency of the mechanical structure.

20. The transformation device of claim 16 wherein said means for oscillating the direction of said forcing means comprises: (a) means for sensing the mechanical motion of said structure, and (b) means for coupling said sensing means with said forcing means.
